(19) United States
(12) Patent Application Publication
(10) Pub. No.: US 2011/0117424 A1
(43) Pub. Date: May 19, 2011

(54) CASE FOR SECONDARY BATTERY AND SECONDARY BATTERY HAVING THE SAME

(75) Inventor: Ho-Seong Kim, Yongin-si (KR)

(73) Assignee: Samsung SDI Co., Ltd., Yongin-si (KR)

(21) Appl. No.: 12/912,684

(22) Filed: Oct. 26, 2010

(30) Foreign Application Priority Data
Nov. 17, 2009 (KR) 10-2009-0110774

(51) Int. Cl. H01M 2/02

(52) U.S. Cl. 429/176; 429/163

(57) ABSTRACT

A secondary battery case with improved extreme temperature exposure characteristics and a secondary battery. The secondary battery case includes: a quadrangular case body receiving and sealing an anode and a cathode, which are insulated from each other at a predetermined distance, and a liquid electrolyte; and at least one safety device that is coupled to the case body, wherein the safety device applies a force in a predetermined direction, wherein the predetermined direction is adjacent to a direction orthogonal to a line and the line extends in a direction orthogonal to a side wall of the case body from the center of gravity of the case body.

### CROSS-REFERENCE TO RELATED APPLICATIONS

This application claims the benefit of Korean Patent Application No. 10-2009-0110774, filed Nov. 17, 2009, in the Korean Intellectual Property Office, the disclosure of which is incorporated herein by reference.

### BACKGROUND

1. Field

Aspects of the present invention relate to a case for a secondary battery with improved extreme temperature exposure characteristics and a secondary battery having the same.

2. Description of the Related Art

A secondary battery is a battery that is recharged and repetitively used and is a kind of a chemical battery that generates electric energy between electrodes by chemical reaction. A secondary battery is one of a lead storage battery, a nickel-cadmium battery, a nickel-hydrogen battery, a lithium-ion battery, a lithium-ion polymer battery, or other similar battery types. The secondary battery is classified into a cylindrical shape, a quadrangular shape, or other similar shapes, according to an external appearance.

The lithium-ion battery has high energy density characteristic per a unit volume. Due to the high energy characteristic, various research has been conducted on the lithium-ion battery in order to apply the lithium-ion battery to digital convergence, a hybrid car, a robot industry, and so on.

### SUMMARY

Aspects of the present invention provide a case for a secondary battery capable of improving safety of a battery by separating the battery in an environment having extreme temperature exposure.

According to another aspect of the present invention there is provided a secondary battery with improved safety against an environment having extreme temperature exposure.

According to an aspect of the present invention, a secondary battery case includes: a quadrangular case body receiving and sealing an anode and a cathode, which are insulated from each other at a predetermined distance, and a liquid electrolyte; and at least one safety device that is coupled to the case body. The safety device applies a force in a predetermined direction, the predetermined direction is adjacent to a direction orthogonal to a line, when one side wall of the case body is expanded to an outer side with respect to the line that extends in a direction orthogonal to a side wall of the case body from the center of gravity of the case body.

According to another aspect of the present invention, the safety device is positioned in an angle range from 70° or more to less than 90° from the center of gravity with respect to the line. To this end, the safety device may be disposed adjacent to a corner of the side wall. In addition, the safety device may be positioned on a line segment that connects a corner of the side wall to a point that is a projection of the center of gravity on the side wall.

According to another aspect of the present invention, the safety device includes end parts having a first depth and a center part having a second depth greater than the first depth.

According to another aspect of the present invention, the center part having the second depth is positioned on a line segment that connects a corner of the side wall to a point that is a projection of the center of gravity on the side wall.

According to another aspect of the present invention, the center part may have a straight shape that is orthogonal to the line segment or a curved shape having a tangent line that is orthogonal to the line segment.

According to another aspect of the present invention, the end parts are disposed at both ends of the center part.

According to another aspect of the present invention, the safety device further includes an auxiliary first groove part extending between the end parts and below the center part.

According to another aspect of the present invention, the end parts may extend to be bent into one side wall from both ends of the center part.

According to another aspect of the present invention, the safety device further includes an auxiliary first groove part that extends between the end parts in parallel with the center part to surround the center part.

According to another aspect of the present invention, the at least one safety device may be a plurality of safety devices that are disposed adjacent to at least two of four corners of the case, respectively.

According to another aspect of the present invention, the at least one safety device includes a second safety device that is disposed on an other side wall facing the side wall.

According to another aspect of the present invention, the case body is made of aluminum or aluminum alloy.

According to another aspect of the present invention, the safety device is formed directly in the case body.

According to the above-mentioned aspects of the present invention, a local vent pressure is lowered and the position and structure of the vent is changed, thereby making it possible to increase the injection power of gas and injection gas in a desired direction due to the increased battery internal pressure. In other words, the battery is easily separated under an environment having an extreme temperature exposure, thereby making it possible to improve the safety of the battery against the extreme temperature exposure.

In addition, since embodiments of the present invention use the vent that is provided in most quadrangular batteries, it does not have to add separate components or largely change the manufacturing process in order to improve the safety against the extreme temperature exposure. Therefore, the embodiments of the present invention can be easily used by the manufacturers of the case for a secondary battery or the manufacturers of the secondary battery.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic diagram explaining how to operate a secondary battery according to an embodiment under an environment having extreme temperature exposure.

FIG. 2 is a schematic perspective view of a case of a secondary battery according to an embodiment of the present invention.

FIG. 3 is a schematic cross-sectional view illustrating a safety device that is provided in the case of a secondary battery of FIG. 2.

FIGS. 4A to 4D are schematic plan views illustrating a safety device according to an embodiment of the present invention.

FIG. 5 is a schematic front view of a case of a secondary battery according to an embodiment of the present invention.

FIG. 6 is a schematic perspective view of a case of a secondary battery according to an embodiment of the present invention.

FIG. 7 is a schematic perspective view illustrating a secondary battery according to an embodiment of the present invention.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

In describing the embodiment, in the figures, the thickness and sizes of each layer may be exaggerated for convenience of description and clarity and may be different from the actual thickness and size. As referred to herein, when a first element is said to be disposed or formed “on”, or “adjacent to”, a second element, the first element can directly contact the second element, or can be separated from the second element by one or more other elements located therebetween. Additionally, it is to be understood that where is stated herein that one element is “formed on” or “disposed on” a second element, the first element may be formed or disposed directly on the second element or there may be intervening elements between the first element and the second element. Further, as used herein, the term “formed on” is used with the same meaning as “located on” or “disposed on” and is not meant to be limiting regarding any particular fabrication process.

In the following description, a term “quadrangular shape” includes an approximate square cross section shape or an approximate flat rectangular cross section shape or other similar shapes having four internal angles.

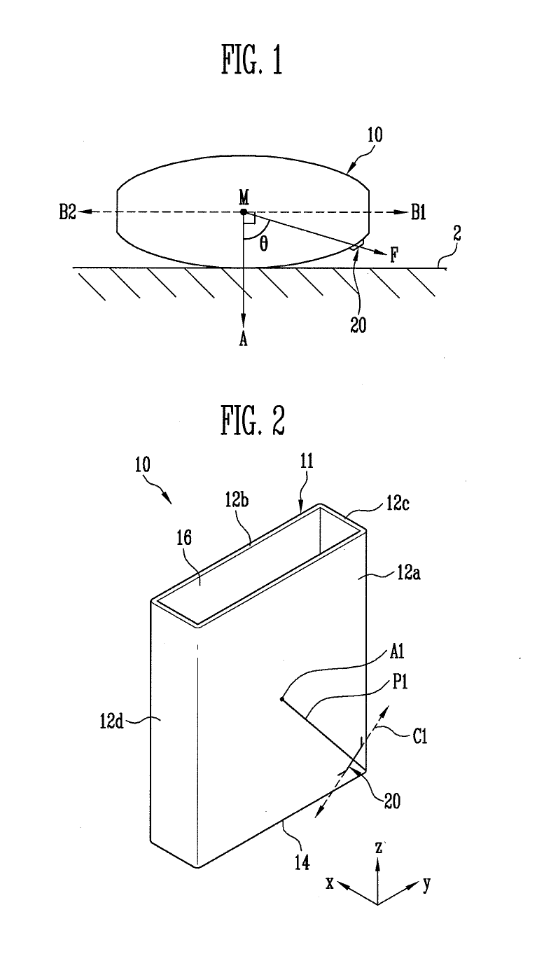

FIG. 1 is a schematic diagram for explaining how to operate a secondary battery according to one embodiment under an environment having extreme temperature exposure. Referring to FIG. 1, a secondary battery according to the present invention includes a case 10 and a safety device 20 that is provided on a side wall of the case 10. The case 10 is made of aluminum or aluminum alloy. However, aspects of the present invention are not limited thereto and other suitable metals may be used. The case 10 surrounds the outside of the secondary battery to protect parts therein. In particular, the case 10 protects the battery from the risk of fire and explosion of the secondary battery.

The safety device 20 discharges gas in the secondary battery at a predetermined internal pressure to prevent the explosion of the secondary battery under an undesired environment, for example, an environment having extreme temperature exposure and is formed to have a temperature threshold lower than the case 10. That is, among parts in the case 10, the safety device 20 is broken first at a predetermined internal pressure.

As an example of an extreme temperature exposure test in order to simulate an environment having extreme temperature exposure, the following operations 1 to 4 can be performed.

In operation 1 a completely charged sample (secondary battery) is prepared. However, it is assumed that the sample of 2600 mA is charged at about 40%. In operation 2, an octagonal wire net whose straight length is about 610 mm and height is about 305 mm is disposed on a heating plate or a heating block 2. The octagonal wire net is prepared so that a metal wire having a diameter of 0.25 mm becomes 16 to 28 wire/inches. In operation 2, when the temperature of the heating block 2 reaches about 750° C. to about 800° C., it is disposed at the central portion of the bottom of the wire net. The heating block 2 has an upper end area larger than the sample and is disposed at the central portion of the wire net. In operation 3, the disposed sample is heated until it generates a flame or is exploded.

The secondary battery, according to an embodiment of the present invention, is designed so as to not explode in the extreme temperature exposure test. In more detail, the secondary battery is designed to withstand a temperature of about 800° C., which is higher than 620° C. to 640° C., which is a melting temperature of the case 10 made of an aluminum can. Therefore, when the secondary battery is left until the extreme temperature exposure test is completed, the case is melted and the separating membrane in the case is contracted to short an anode and a cathode. However, in the embodiment, when the internal pressure increases above a predetermined level in the battery, by controlling the structure and position of the safety device 20, a part of the safety device 20 is locally broken. Thus, the battery is easily separated from the extreme temperature exposure place by the propulsive force of the internal pressure that is strongly discharged through the locally broken safety device 20. According to the present embodiment having the safety device 20, the explosion of the quadrangular lithium-ion secondary battery can be prevented in the extreme temperature exposure test.

The safety device 20 is provided to apply a force in a direction F (hereinafter, referred to as a first direction), which is adjacent to a direction B1 orthogonal to a line A that extends in a direction orthogonal to one side wall of the case 10 contacting the upper end surface of the heating block 2 from the center of gravity of the case 10. Herein, the direction that the center of gravity M orthogonal to one side wall of the case 10 is a direction that is also orthogonal to one side wall (see reference numeral 12a of FIG. 2) in the state where the case 10 is not expanded.

An angle θ of the first direction F, with respect to the line A, is in the range of about 70° or more to less than about 90°. When the safety device is formed in the angle range, the secondary battery can be appropriately separated from the extreme temperature exposure area by directing the propulsive force of the internal pressure in a predetermined direction.

When the angle θ is less than 70° or the angle θ is 90°, the secondary battery is rotated about a central portion of one side wall contacting the heating block 2, and towards which the line A extends in a direction orthogonal to the side wall of the case 10, even when both side walls of the secondary battery are expanded in the environment having the extreme temperature exposure, and thus, a vent is then broken. Therefore, when the safety device is not installed at a position that has an approximate angle with respect to the line A, it is difficult to separate the secondary battery from the extreme temperature exposure place and to avoid the explosion of the secondary battery.

Hereinafter, the case for a secondary battery and the safety device according to an embodiment will be described in more detail.

FIG. 2 is a schematic perspective view of a secondary battery case according to an embodiment. Referring to FIG. 2, the case 10 of a secondary battery includes a quadrangular case. The case 10 includes a first long side wall 12a and a second long side wall 12b that face each other at a predetermined distance and a first short side wall 12c and a second short side wall 12d that connects the first long side wall 12a and the second long side wall 12b. Herein, widths in a y direction of the first long side wall 12a and the second long side wall 13b are larger than widths in an x direction of the first short side wall 12c and the second short side wall 12d. In other words, the case 10 includes two opposing main walls 12a and 12b and two opposing side walls 12c and 12d connecting the main walls. The two main walls 12a and 12b each have a surface area greater than a surface area of either of the side walls 12c and 12d.

Additionally, the case 10 includes a bottom wall 14 that connects the lower end portions of the first long side wall 12a and the second long side wall 12b and the first short side wall 12c and the second short side wall 12d and closes off one side of a quadrangular box structure formed by four side walls. The case 10 has an opening part 16 that is formed at the other side of the quadrangular box structure formed by the four side walls 12a, 12b, 12c, and 12d which are included in the case body 11. The first long side wall 12a, the second long side wall 12b, the first short side wall 12c, and the second short side wall 12d, and the bottom wall 12 are integrally formed using a single material. However, aspects of the present invention are not limited thereto.

The case 10 includes the safety device 20 that is formed at one side wall 12a. The safety device 20 is provided so that it breaks at the predetermined internal pressure of the secondary battery in order to prevent fire and explosion of a lithium-ion secondary battery using the case 10.

In the present embodiment, the safety device 20 is disposed adjacent to one corner of the one side wall 12a of the case 10. The safety device 20 is disposed in such a manner so as to have an angle of about 70° or more with respect to a direction (line A of FIG. 1) orthogonal to one side wall 12a from the center of gravity of the case 10 or the center of gravity of the lithium-ion secondary battery using the case 10.

In another embodiment of the present invention, the safety device 20 is positioned on a line segment P1 that connects a point A1 to a corner adjacent to the safety device 20. The point A1 is a projection of the center of gravity of the case 10 or the center of gravity of the lithium-ion secondary battery using the case 10 on one side wall 12a.

As described above, the safety device 20 is positioned in the angle range of about 70° or more to less than 90° with respect to a direction (line A of FIG. 1) that is orthogonal to one side wall 12a from the center of gravity of the case 10 or the center of gravity of the lithium-ion secondary battery using the case 10. The operation of the safety device 20 is further enhanced by considering an installation position of the safety device 20 and a structure of the safety device 20.

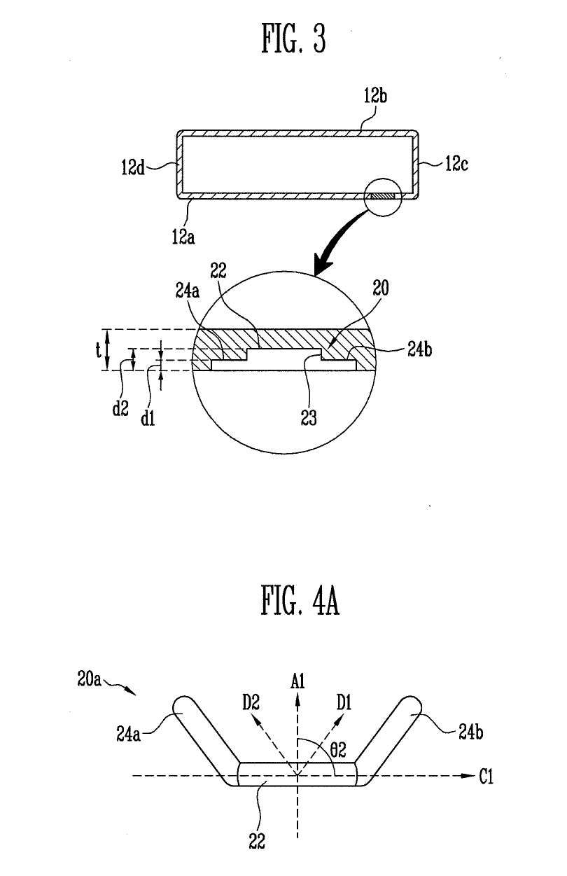

FIG. 3 is a schematic cross-sectional view illustrating a safety device that is provided in the case of a secondary battery of FIG. 2. Referring to FIG. 3, the safety device 20, which is provided on one side wall of the case 12a, may include a groove that is depressed when being viewed from the outside of the case. In particular, the safety device 20 includes a strong part 23 having a first depth d1 and a weak part 22 having a second depth d2 deeper than the first depth d1. In other words, the weak part 22 is a center part 22 of the safety device 20 and the strong part 23 is end parts 23 disposed at both ends of the center part 22. When the safety device 20 is formed at the first depth d1 and the second depth d2, a sufficient injection power is formed by narrowing the injector of the internal gas while sequentially opening the safety device 20 at a predetermined internal pressure.

In an embodiment, the second depth d2 corresponds to about 40% to 60% of a thickness t of one side wall 12a. Although this range may be slightly different according to a length of the portion having the second depth or the material of the side wall, it is set to easily break the case at the predetermined internal pressure while not deteriorating the durability of the case 10. The first depth d1 is shallower than the second depth d2. In other words, the portion having the first depth d1 (hereinafter, referred to as a first groove part) is formed to be broken later than the portion having the second depth d2 (hereinafter, referred to as a weak part) when the internal pressure of the secondary battery including the case 10 is increased.

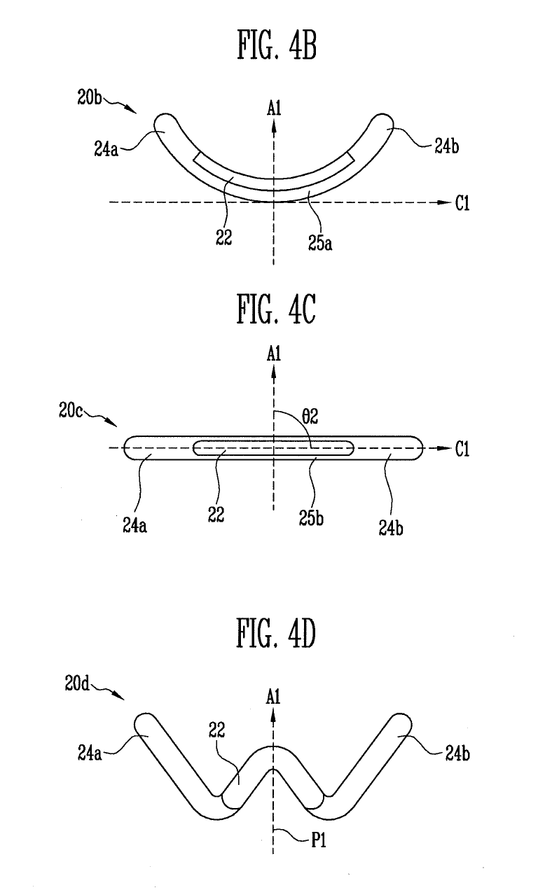

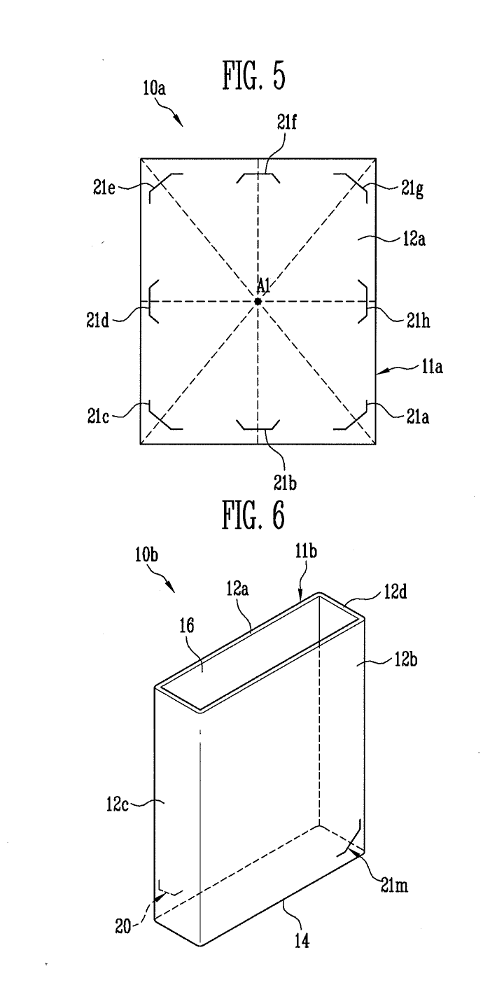

FIGS. 4A to 4D are schematic plan views for explaining the safety device according to another embodiment. Referring to FIG. 4A, the safety device 20a, according to an embodiment of the present invention, includes a weak part 22 and first groove parts 24a and 24b each of which extends to the outside from respective ends of the weak part 22. Each of the first groove parts 24a and 24b extends to be bent in directions D1 and D2 having a predetermined angle toward a point A1 projecting the center of gravity on one side wall of the case.

In an embodiment, the weak part 22 of the safety device 20a is disposed on the straight line C1 that extends in a direction intersecting with the line segment P1. It is preferable that a second angle θ2, at which the line segment P1 intersects with the straight line C1, is in an angle range of 70° or more to 110° or less. When the second angle θ2 is in an angle range of less than 70° to above 110°, the discharge pressure of the internal gas of the battery discharged through the weak part 22 when the weak part 22 is broken rotates the battery around the original place, which is not preferable.

Referring to FIG. 4B, the safety device 20b, according to an embodiment of the present invention, has an arc shape and includes the weak part 22 positioned at a middle portion of the arc shape and the first grooves 24a and 24b positioned at both ends of the weak part 22. The safety device 20b extends in parallel with the weak part 22 between the first groove parts 24a and 24b and includes an auxiliary first groove part 25a having the first depth. The first groove parts 24a and 24b and the auxiliary first groove part 25a form the boundary of the weak part 22, and when the internal pressure of the secondary battery is increased to a predetermined amount or more, they are broken later than the weak part 22.

Referring to FIG. 4C, the safety device 20c, according to an embodiment of the present invention, has a straight shape and includes the weak part 22 positioned at a middle portion of the straight shape and the first grooves 24a and 24b positioned at respective ends of the weak part 22. The safety device 20b extends to surround the weak part 22 between the first groove parts 24a and 24b and includes an auxiliary first groove part 25b having the first depth d1. The first groove parts 24a and 24b and the auxiliary first groove part 25b form the boundary of the weak part 22, and when the internal pressure of the secondary battery is increased to a predetermined amount or more, they are broken later than the weak part 22.

In an embodiment, the weak part 22 of the safety device 20c is disposed on the straight line C1 that extends in a direction intersecting with the line segment P1 (see FIG. 2), similar to the weak part of FIG. 4A. A second angle θ2, at which the line segment P1 intersects with the straight line C1, is in the range of 70° or more to 110° or less. When the second angle θ2 is in the range of less than 70° to above 110°, the discharge pressure of the internal gas of the battery discharged through the weak part when the weak part is broken rotates the battery around the original place, which is not preferable.

Referring to FIG. 4D, the safety device 20d, according to another embodiment of the present invention, has a W-letter shape and includes the weak part 22 positioned at a middle portion of the W-letter shape and the first grooves 24a and 24b positioned at respective ends of the weak part 22.

In the present embodiment, the weak part 22 of the safety device 20d does not extend in a direction that is approximately orthogonal to the line segment P1 that connects the point A1 projecting the center of gravity on the one side wall of the case to the corner of one side wall adjacent to the safety device 20d. Nevertheless, the safety device 20d is installed adjacent to one corner of one side wall and includes the groove form in a two-stage structure, thereby making it possible to perform functions similar to the above-mentioned other safety units.

With respect to the above-mentioned safety devices 20a, 20b, 20c, and 20d, when the internal pressure of the secondary battery is increased to the predetermined pressure or more, the safety device is partially and sequentially opened on the expanded one side wall of the case, such that it has the sufficient injection power in the desired direction, thereby making it possible to separate the secondary battery at the extreme temperature exposure place.

FIG. 5 is a schematic front view of the case of a secondary battery according to another embodiment. A case 10a, according to an embodiment of the present invention, includes a case body 11a and a plurality of safety devices formed on one side wall 12a of the case body 12a. For example, as shown in FIG. 5, the safety devices 21a, 21b, 21c, 21d, 21e, 21f, 21g, and 21h are provided at least two of eight positions represented on one side wall 12a of the case 10a.

As described above in FIG. 1, each safety device is provided to apply a force in a direction adjacent to a direction that is orthogonal to a line that extends in a direction orthogonal to the center of gravity of the case 10a or the center of gravity of the secondary battery using the case 10a. The safety devices are provided at least any two of portions that are adjacent to four corners and four sides of a side wall 12a. In FIG. 5, each safety device is disposed adjacent to each corner or each side on the line segment that connects on the point A1 to the corner or the side at which the safety device is positioned. The point A1 is a projection of the above-mentioned center of gravity on the side wall 12a of the case 10a.

When the internal pressure of the secondary battery is increased at the extreme temperature atmosphere of about 800° C., it is possible to obtain a two-stage injection power or a three-stage injection power according to the state of the expanded secondary battery by using the plurality of safety devices. In other words, after a first safety device 21a is broken under the extreme temperature exposure, the second safety device 21b or the second and third safety devices 21b, 21c are sequentially broken to be operated.

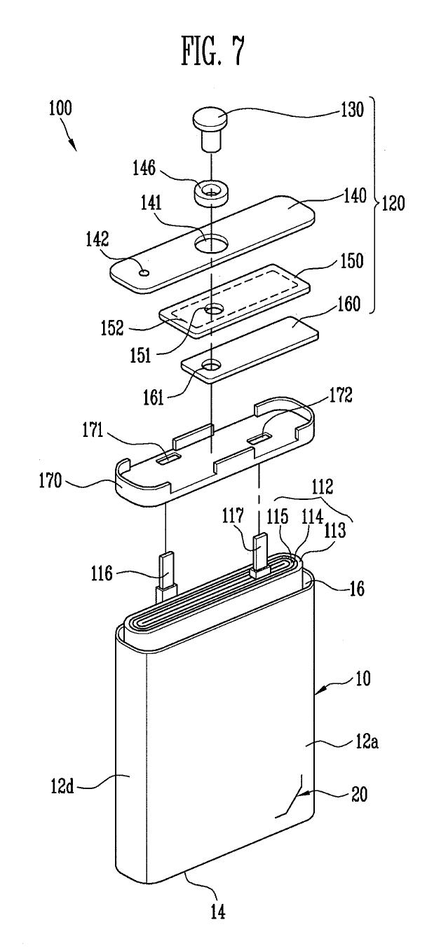

FIG. 6 is a schematic perspective view of a case 10b of a secondary battery according to another embodiment of the present invention. Referring to FIG. 6, the case 10b includes a case body 11b, a first safety device 20 on a side wall 12a of the case body 11b, and a second safety device 21m on another side wall 12b of the case body 11b. The other side wall 12b faces the side wall 12a and the side walls 12a and 12b have a predetermined distance between them. The side wall 12a and the other side wall 12b are two long side walls of the case body 11b and have larger surface areas than side walls 12c and 12d.

By forming the first safety device 20 and the second safety devices 21m on the side wall 12a and the other side wall 12b, respectively, when the quadrangular secondary battery 10b is in an environment having extreme temperature exposure, a same effect is obtained if either the first long side wall 12a or the second long side wall 12b is disposed at a side to which heat is applied. In other words, in the first safety device 20 and the second safety device 21m are disposed at two opposing side walls, a safety device positioned at a long side wall to which heat is applied may open first and the remaining safety devices may open later.

FIG. 7 is a schematic perspective view illustrating a secondary battery according to an embodiment of the present invention. Referring to FIG. 7, a secondary battery 100, according to the present embodiment, includes the case 10 that includes the safety device 20, an electrode assembly 112 that is disposed in the case 10, and a cap assembly 120 that seals the upper end opening part 16 of the case 10. Herein, the safety device 20 has a two-stage structure having a first depth d1 and a second depth d2 and is disposed adjacent to one corner of a side wall 12a of the case 10 and is disposed so that the weak part 23 (not shown) in the two-stage structure is approximately orthogonal to a center of gravity of the case 10.

The secondary battery 100 expels the strong internal gas through the safety device 20 that is broken by the predetermined internal pressure of the battery under the environment having extreme temperature exposure and injects the internal gas in a direction that is orthogonal to a predetermined plane, such that it can be easily separated at the extreme temperature exposure (see FIG. 1). The predetermined plane may be a plane in parallel with one side wall 12a of the case 10, a bottom plane raising one side wall 12a under the environment having extreme temperature exposure, or the upper end plane of the heating block 2 for the extreme temperature exposure test. In the secondary battery 100, the case 100 surrounds the outer portion of the quadrangular battery to protect parts therein. The case 10 is substantially the same as the case described with reference to FIG. 2.

The electrode assembly 112 includes a first electrode plate 113, a second electrode plate 115, and a separator 114. The first electrode plate 113 is formed of an anode plate and the second electrode plate 115 is formed of a cathode layer. However, aspects of the present invention are not limited thereto. The first electrode plate 113 and the second electrode plate 115 are stacked having the separator 114 interposed there between, and may be then wound in a jelly roll form. A first electrode tab 116 is welded to the first electrode plate 113 and a second electrode tab 117 is welded to the second electrode plate 115. An end of the first electrode tab 116 and an end of the second electrode tab 117 are protruded up.

The cap assembly 120 includes a cap plate 140, an insulating plate 150, a terminal plate 160, and an electrode terminal 130. The cap assembly 120 is coupled with the upper end opening part 16 of the case 10 via the separate insulator 170 to seal the case 10.

The cap plate 140 is formed of a metal plate in a size and a shape that corresponds to the upper end opening part 16 of the case 11. As a material of the cap plate 140, lightweight aluminum or aluminum alloy is used. However, aspects of the present invention are not limited thereto, and other suitable materials may be used for the cap plate 140. A first terminal through hole 141 having a predetermined size is formed at the center of the cap plate 140 and an electrolyte injection hole 142 is formed at one side of the cap plate 140.

The first terminal through hole 141 is formed to have a diameter larger than the electrode terminal 130. The electrode terminal 130 is inserted into the first terminal through hole 141 via a gasket tube 146. The gasket tube 146 insulates between the electrode terminal 130 and the cap plate 140.

After the cap assembly 120 is assembled on the upper end opening part 16 of the case 10, the electrolyte liquid is injected through the electrolyte injection hole 142. The electrolyte injection hole 142 is sealed by a separate sealing device (not shown).

The insulating plate 150 insulates between the cap plate 140 and the terminal plate 160. An insertion groove 152 is provided at a size corresponding to a size of the terminal plate 160 so that the terminal plate 160 is inserted into a bottom surface of the insulating plate 150. The insulating plate 150 includes a second terminal through hole 151 at a position corresponding to the first terminal through hole 141. The second terminal through hole 151 is formed to have approximately a same diameter as a diameter of the electrode terminal 130.

The terminal plate 160 is formed in a plate shape of nickel or nickel alloy. The terminal plate 160 includes a third terminal through hole 161 at a position that corresponds to the second terminal through hole 151 of the insulating plate 150. The electrode terminal 130, which penetrates through the second terminal through hole 151, is inserted in and connected to the third terminal through hole 161.

The insulator 170 includes a first electrode tab hole 171 and a second electrode tab hole 172. The first electrode tap 116 is connected to the cap plate 140 by penetrating through the first electrode tab hole 171 and the second electrode tab hole 117 is connected to the electrode terminal 130 by penetrating through the second electrode tab hole 172. The insulator 170 is coupled with the lower portion of the cap assembly 120 to electrically insulate the cap assembly 120 and the electrode assembly 112.

The secondary battery 100 of the embodiment includes the safety device 20 having a specific structure at a specific position. Therefore, the secondary battery 100 is separated at the place under the environment having extreme temperature. Thus, the safety device 20 prevents the secondary battery 100 from progressing to an exposure mode, which may include fire and explosion, under an environment having extreme temperature exposure.

Meanwhile, the above-mentioned embodiments described the case where the safety device is directly formed in the case body. However, aspects of the present invention are not limited thereto. According to aspects of the present invention, at least one safety device may be prepared as a separate part according to the above-mentioned embodiments and may be coupled with the case body rather than being directly formed in the case body.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A secondary battery case, comprising:
a quadrangular case body receiving and sealing an anode and a cathode, which are insulated from each other at a predetermined distance, and a liquid electrolyte; and
at least one safety device that is coupled to the case body,
wherein the safety device applies a force in a predetermined direction,
wherein the predetermined direction is adjacent to a direction orthogonal to a line, and
wherein the line extends in a direction orthogonal to a side wall of the case body from the center of gravity of the case body.

2. The secondary battery case of claim 1, wherein the safety device is positioned in an angle range from 70° or more to less than 90° from the center of gravity with respect to the line.

3. The secondary battery case of claim 1, wherein the safety device may be disposed adjacent to a corner of the side wall.

4. The secondary battery case of claim 1, wherein the safety device is positioned on a line segment that connects a corner of the side wall to a point that is a projection of the center of gravity on the side wall.

5. The secondary battery case of claim 1, wherein the safety device comprises:
end parts having a first depth; and
a center part having a second depth greater than the first depth.

6. The secondary battery case of claim 5, wherein the center part having the second depth is positioned on a line segment that connects a corner of the side wall to a point that is a projection of the center of gravity on the side wall.

7. The secondary battery case of claim 6, wherein the center part has a straight shape that is orthogonal to the line segment or a curved shape having a tangent line that is orthogonal to the line segment.

8. The secondary battery case of claim 7, wherein the end parts are disposed at both ends of the center part.

9. The secondary battery case of claim 8, wherein the safety device further comprises an auxiliary first groove part extending between the end parts and below the center part.

10. The secondary battery case of claim 8, wherein the end parts extend to be bent into one side wall from both ends of the center part.

11. The secondary battery case of claim 10, wherein the safety device further comprises an auxiliary first groove part that extends between the end parts in parallel with the center part to surround the center part.

12. The secondary battery case of claim 1, wherein the at least one safety device is a plurality of safety devices that are disposed adjacent to at least two of four corners of the case, respectively.

13. The secondary battery case of claim 1, wherein the at least one safety device comprises a second safety device that is disposed on an other side wall facing the side wall.

14. The secondary battery case of claim 1, wherein the safety device is formed directly in the case body.

15. A secondary battery, comprising:
an electrode assembly including an anode and a cathode that are insulated from each other at a predetermined distance and a liquid electrolyte; and
a case comprising:
a quadrangular case body receiving and sealing an anode and a cathode, which are insulated from each other at a predetermined distance, and a liquid electrolyte; and
at least one safety device that is coupled to the case body,
wherein the safety device applies a force in a predetermined direction,
wherein the predetermined direction is adjacent to a direction orthogonal to a line, and
wherein the line extends in a direction orthogonal to a side wall of the case body from the center of gravity of the case body.

16. The secondary battery case of claim 15, wherein the case body is made of aluminum or aluminum alloy.
